(19) United States
(12) Patent Application Publication
(10) Pub. No.: US 2021/0282376 A1
(43) Pub. Date: Sep. 16, 2021

(54) INOCULUM TRANSFER APPARATUS AND RELATED METHODS

(71) Applicant: Bee Vectoring Technology Inc., Mississauga (CA)

(72) Inventors: Ian Michael Collinson, Toronto (CA); Peter Dicks, Mississauga (CA)

(73) Assignee: Bee Vectoring Technology Inc., Mississauga (CA)

(21) Appl. No.: 17/303,417

(22) Filed: May 28, 2021

Related U.S. Application Data
(63) Continuation of application No. PCT/CA2019/051702, filed on Nov. 28, 2019.
(60) Provisional application No. 62/772,181, filed on Nov. 28, 2018.

(51) Int. Cl. A01K 51/00; A01K 47/06

(52) U.S. Cl. CPC A01K 51/00; A01K 47/06

(57) ABSTRACT

An inoculum transfer apparatus for a bee hive having a hive opening includes: (a) a body mountable to the hive; (b) a bee pathway in the body for providing passage for bees between the hive opening and an outside environment external the hive; (c) a reservoir in the body above the bee pathway for storing a powdered inoculum, the reservoir having a reservoir outlet at a lower end thereof; and (d) a vibratory dispenser in the body adjacent the reservoir outlet for controlling dispensing of the powdered inoculum from the reservoir outlet to the bee pathway via a vibratory drive.

### CROSS-REFERENCE TO RELATED APPLICATIONS

This application is a continuation of International Patent Application No. PCT/CA2019/051702, filed Nov. 28, 2019, entitled “INOCULUM TRANSFER APPARATUS AND RELATED METHODS”, which claims the benefit of U.S. Provisional Patent Application No. 62/772,181, filed Nov. 28, 2018, entitled “INOCULUM TRANSFER APPARATUS AND RELATED METHODS”, each of which is hereby incorporated herein by reference in its entirety.

### FIELD

This disclosure relates generally to bee hives, and more specifically, to inoculum transfer apparatuses for bee hives and related methods.

### BACKGROUND

U.S. Pat. No. 3,069,702 (Reed) discloses an apparatus for coating honey bees with pollen for improving pollination of plant blossom by said honey bees. The apparatus includes an automatic feeder device which automatically deposits pollen at the required rate into a trough through which honey bees walk as they leave a beehive.

U.K. Pat. No. 1,470,385 (Legge) discloses a dispenser, suitable for applying a coating substance, e.g. pollen or antibiotic compound to bees emerging from a hive, comprising an inverted bottle, containing the coating substance and mounted above a channelled shoot in a hopper, at the base of which is a horizontal roller with a surface array of conical depressions. Removal of a seal by a manual slide results in the coating substance being released into the hopper and distributed in a fine curtain from the rotating roller.

U.S. Pat. No. 9,357,752 (Collinson et. al.) discloses a tray for positioning in an exit path of a bee hive including a base, a bee entrance end, and a bee exit end. Spaced apart side walls extend upwardly from the base. The sidewalls extend generally lengthwise between the bee entrance end and bee exit end. A plurality of posts extend upwardly from the base and are positioned between the bee entrance end and the bee exit end. The posts are generally circular in cross-section. The posts act as obstacles around which the bees must walk to reach the bee exit end from the bee entrance end.

### SUMMARY

The following summary is intended to introduce the reader to various aspects of the applicant's teaching, but not to define any invention.

According to some aspects, an inoculum transfer apparatus for a bee hive having a hive opening includes: (a) a body mountable to the hive intermediate the hive opening and an outside environment; (b) a bee pathway in the body for providing passage for bees between the hive opening and the outside environment; (c) a reservoir in the body at an elevation above the bee pathway for storing powdered inoculum, the reservoir having a reservoir outlet at a lower end thereof; and (d) a vibratory dispenser in the body adjacent the reservoir outlet for controlling dispensing of the powdered inoculum from the reservoir outlet to the bee pathway via a vibratory drive.

In some examples, the vibratory dispenser includes a gate below the reservoir outlet and coupled to the vibratory drive. The gate inhibits transfer of powdered inoculum from the reservoir outlet to the bee pathway when at rest, and the vibratory drive is energizable to vibrate the gate for inducing transfer of powdered inoculum from the reservoir outlet to the bee pathway.

In some examples, the gate has an upper surface facing the reservoir outlet for receiving the powdered inoculum.

In some examples, the gate vibrates in a plane generally parallel with the upper surface when the vibratory drive is energized.

In some examples, the gate vibrates away from and toward the reservoir outlet when the vibratory drive is energized.

In some examples, the gate vibrates between a closed position against the reservoir outlet and an open position spaced apart from the reservoir outlet when the vibratory drive is energized.

In some examples, the gate is biased toward the closed position.

In some examples, when the gate is in the open position, a transfer channel is provided between the reservoir outlet and the bee pathway for transfer of the powdered inoculum from the reservoir to the bee pathway, and when the gate is in the closed position the transfer channel is closed.

In some examples, the gate pivots about a horizontal pivot axis when vibrating between the open and closed positions.

In some examples, the vibratory dispenser includes a mount fixed to the body, and the gate is pivotably connected to the mount at the pivot axis via a living hinge. In some examples, the living hinge biases the gate toward the closed position.

In some examples, the vibratory drive comprises a vibratory disc motor.

In some examples, the body includes a frame mountable to the hive and a housing removably mountable to the frame. The reservoir is internal the housing and the dispenser mounted to the housing. In some examples, the housing includes a lid movable between an open position for providing access to the reservoir, and a closed position for covering the reservoir.

In some examples, wherein the apparatus further includes a controller for controlling operation of the vibratory drive according to one or more adjustable operating parameters.

In some examples, the operating parameters correspond to at least one of a frequency of vibration and an amplitude of vibration.

In some examples, the operating parameters correspond to at least one of a dispensing time period during which to energize the vibratory drive, and an off time period during which to not energize the vibratory drive.

An inoculum transfer apparatus for a bee hive having a hive opening includes: (a) a body mountable to the hive; (b) a bee pathway in the body for providing passage for bees between the hive opening and an outside environment external the hive; (c) a reservoir in the body above the bee pathway for storing a powdered inoculum, the reservoir having a reservoir outlet at a lower end thereof; and (d) a dispenser in the body for controlling dispensing of the powdered inoculum from the reservoir to the bee pathway. The dispenser includes a gate adjacent the reservoir outlet. The gate is movable between a first position in which the reservoir outlet is closed by the gate to inhibit transfer of the powdered through the reservoir outlet, and a second position spaced apart from the first position and in which the reservoir outlet is open to facilitate dispensing the powdered inoculum from the reservoir toward the bee pathway. The dispenser further includes a drive coupled to the gate for moving the gate at least from the first position to the second position.

In some examples, the gate is biased toward the first position. In some examples, the gate is pivotable about an axis for movement between the first and second positions.

A method of inoculating bees passing through an inoculum transfer apparatus mounted to a bee hive includes: (a) supplying a reservoir of the apparatus with powdered inoculum, the reservoir including a reservoir outlet at a lower end thereof; and (b) periodically energizing a vibratory drive to vibrate a gate positioned below the reservoir outlet to induce transfer of the powdered inoculum from the reservoir to the bee pathway to dust bees exiting the hive via the bee pathway with the powdered inoculum.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of an example inoculum transfer apparatus for a bee hive;

FIG. 2 is a cross-sectional view of the apparatus of FIG. 1, taken along line 2-2 of FIG. 1, and showing a cartridge loaded in the apparatus and a dispenser of the apparatus in a first configuration;

FIG. 3A is an enlarged view of a portion of FIG. 2, but without the cartridge and inoculum shown in FIG. 2;

FIG. 3B is an enlarged view like that of FIG. 3A, but showing the dispenser in a second configuration;

FIG. 4 is a cross-sectional view of the apparatus of FIG. 1, taken along line 4-4 of FIG. 2;

FIG. 5 is an exploded perspective view of the apparatus of FIG. 1;

FIG. 6 is a simplified schematic diagram of the dispenser and control components of the apparatus of FIG. 1;

FIG. 7 is a flow chart illustrating an example method of inoculating bees passing through the apparatus of FIG. 1;

FIG. 8 is a perspective view of another example inoculum transfer apparatus for a bee hive; and

FIG. 9 is a cross-sectional view of the apparatus of FIG. 8, taken along line 9-9 of FIG. 8.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

Disclosed herein are examples of an inoculum transfer apparatus for a bee hive. The bee hive can include, for example, a honey bee hive. The apparatus can be mounted to the bee hive, so that bees (e.g. honey bees) entering and/or exiting the hive pass through the apparatus. As the bees pass through the apparatus, they are dusted with an inoculum. The inoculum can be in the form of a powder, and can include any substance for depositing onto a bee, for example for the benefit of the bee, the hive, or plants visited by the bee (i.e. the inoculum can be delivered to plants by the bees, in a process known as bee vectoring). For example, the inoculum can include a plant treatment agent (e.g. a fungus that is beneficial to plants, a pollen, or a fertilizer), a bee treatment agent, and/or a hive treatment agent (e.g. a miticide).

The inoculum can be stored in a reservoir (e.g. a receptacle, hopper, and/or cartridge) of the apparatus, and the inoculum can be dispensed from the reservoir into a bee pathway of the system, so that bees entering and/or exiting the hive via the pathway are dusted with the inoculum (either by walking through inoculum deposited in the pathway, or by the inoculum being deposited directly on the bees). The inoculum can then be delivered to, for example, plants by the bees, delivered into the hive by the bees, and/or treat bees dusted with the inoculum.

The apparatus can include a vibratory dispenser for controlling dispensing of the powdered inoculum from the reservoir to the bee pathway via a vibratory drive. Utilizing vibrations to help control dispensing of the inoculum can, for example, help reduce cost and complexity of the apparatus relative to some other dispenser designs. The dispenser can be tuned so that the inoculum is deposited into the pathway slowly over time, for example at preset time intervals (e.g. of around 90 seconds), so that the bees are dusted with an effective amount of inoculum, but so that wastage of the inoculum is minimized, and so that the reservoir can be resupplied with inoculum (e.g. by being filled directly or through loading of a cartridge replacement) relatively infrequently (e.g. after 2 weeks).

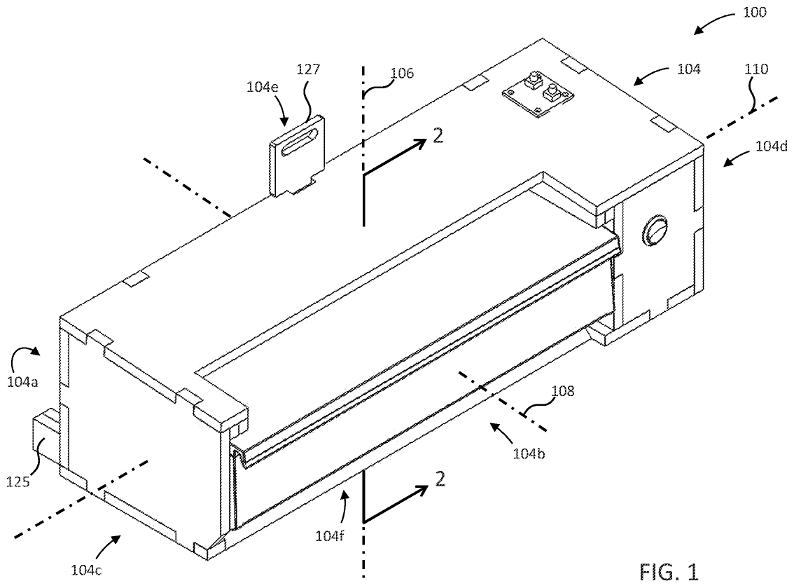

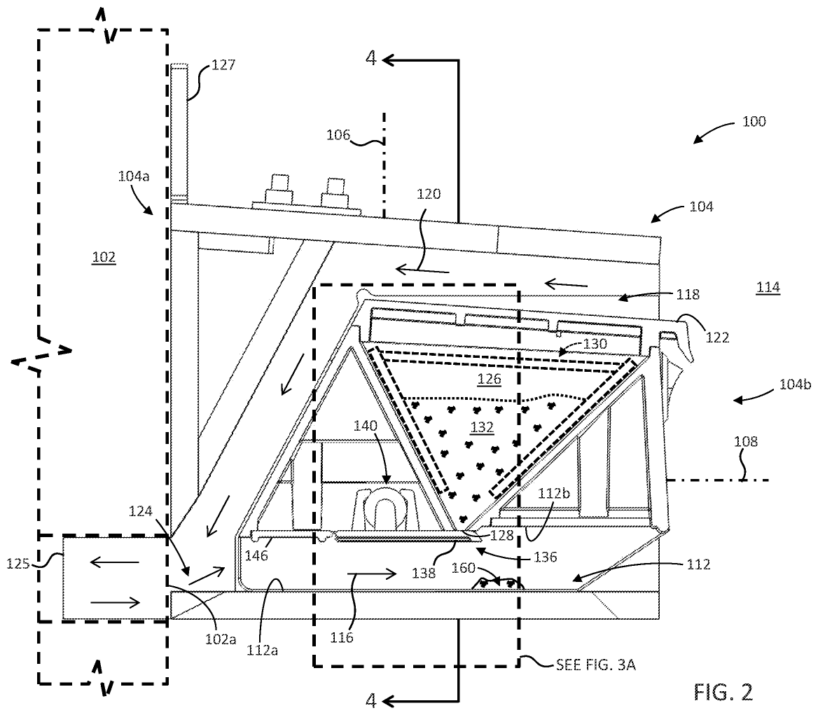

Referring to FIG. 1, an example inoculum transfer apparatus 100 is shown. Referring to FIG. 2, the inoculum transfer apparatus 100 is for a bee hive 102 having a hive opening 102a (shown schematically in FIG. 2). The hive 102 can include, for example, a honey bee hive. The apparatus 100 includes a body 104 mountable to the hive 102 intermediate the hive opening 102a and an outside environment 114 external the hive 102.

Still referring to FIG. 2, in the example illustrated, when the body 104 is mounted to the hive 102, the body 104 has a rear side 104a directed toward the hive 102, and a front side 104b opposite the rear side 104a and directed away from the hive 102. Referring to FIG. 1, the body has spaced apart left and right sides 104c, 104d extending between the front and rear sides 104a, 104b, and spaced apart top and bottom ends 104e, 104f above and below, respectively, the front, rear, left, and right sides 104a-d. In the example illustrated, the body 104 extends between the top and bottom sides 104e, 104f along a vertical axis 106, between the rear and front sides 104a, 104b along a horizontal first axis 108 generally perpendicular to the vertical axis 106, and between the left and right sides 104c, 104d along a horizontal second axis 110 generally perpendicular to the vertical and first axes 106, 108.

Referring to FIG. 2, in the example illustrated, a first bee pathway 112 is provided in the body 104. In the example illustrated, the first bee pathway 112 extends at least partially between the hive opening 102a and the outside environment 114. The first bee pathway 112 provides passage for bees between the hive opening 102a and the outside environment 114 when the body 104 is mounted to the hive 102. In the example illustrated, the first bee pathway 112 permits passage of bees through the body 104 in at least a first pathway direction 116 generally toward the front side 104b of the body 104. The first pathway direction 116 is generally parallel to the horizontal first axis 108 of the body 104. In the example illustrated, the first bee pathway 112 serves as a hive exit.

In the example illustrated, the body 104 further includes a second bee pathway 118. The second bee pathway 118 extends at least partially between the hive opening 102a and the outside environment 114. In the example illustrated, the second bee pathway 118 provides passage for bees between the outside environment 114 and the hive opening 102a. In the example illustrated, the second bee pathway 118 permits passage of bees through the body 104 in a second pathway direction 120 generally toward the rear side 104a of the body 104. In the example illustrated, the second bee pathway 118 serves as a hive entrance. In the example illustrated, the body 104 includes a landing pad 122 in communication with the second bee pathway 118 for attracting bees to enter the hive 102 via the second bee pathway 118.

In the example illustrated, the second bee pathway 118 is separate from the first bee pathway 112. In the example illustrated, the second bee pathway 118 is spaced vertically apart from the first bee pathway 112. In the example illustrated, the second bee pathway 118 is above the first bee pathway 112.

In the example illustrated, the body 104 includes a pathway header 124 providing communication between the first bee pathway 112 and the hive opening 102a and between the second bee pathway 118 and the hive opening 102a, when the body is mounted to the hive 102. In the example illustrated, the pathway header 124 is open to the rear side 104a of the body 104, and each of the first pathway 112 and the second bee pathway 118 extends from the pathway header 124 to the front side 104b of the body 104.

In the example illustrated, the body 104 includes a set of installation posts 125 insertable into the hive opening 102a for positioning the pathway header 124 in communication with the hive opening 102a during installation (see also FIG. 1), and a mounting bracket 127 for mounting the body 104 to the hive 102.

Still referring to FIG. 2, in the example illustrated, the apparatus 100 includes a reservoir 126 in the body 104 at an elevation above the first bee pathway 112 for storing a powdered inoculum. In some examples, the inoculum can include a powdered plant treatment agent, for delivery to a target plant by the bees as they forage.

In the example illustrated, the reservoir 126 has a reservoir outlet 128 at a lower end thereof. In the example illustrated, the reservoir 126 comprises an optional cartridge 130 (shown schematically in dashed lines in FIG. 2) removably received in the body 104. The cartridge 130 includes an internal chamber 132 for holding the powdered inoculum. In the example illustrated, the internal chamber 132 is in fluid communication with the reservoir outlet 128 when the cartridge 130 is loaded in the body 104 for supplying the inoculum from the chamber 132 to the reservoir outlet 128. Supplying the inoculum in a cartridge may help to, for example, maintain freshness of the inoculum, and can allow for convenient resupply of inoculum through replacement of a depleted cartridge with a fresh cartridge. In the example illustrated, the reservoir 126 is vertically intermediate the first and second bee pathways 112, 118 (with the first bee pathway below the reservoir 126 and the second bee pathway 118 above the reservoir 126 in the example illustrated).

In the example illustrated, the apparatus 100 further includes a vibratory dispenser 136 in the body 104 for controlling dispensing of the powdered inoculum from the reservoir outlet 128 into the first bee pathway 112 via a vibratory drive 140.

In the example illustrated, the dispenser 136 includes a gate 138 adjacent the reservoir outlet 128 and coupled to the vibratory drive 140. In the example illustrated, the gate 138 is below the reservoir outlet 128. In the example illustrated, the gate 138 inhibits transfer of the powdered inoculum from the reservoir outlet 128 into the first bee pathway 112 when at rest (e.g. when not vibrating). In the example illustrated, the vibratory drive 140 is energizable to vibrate the gate 138 to induce transfer of the powdered inoculum from the reservoir outlet 128 into the first bee pathway 112.

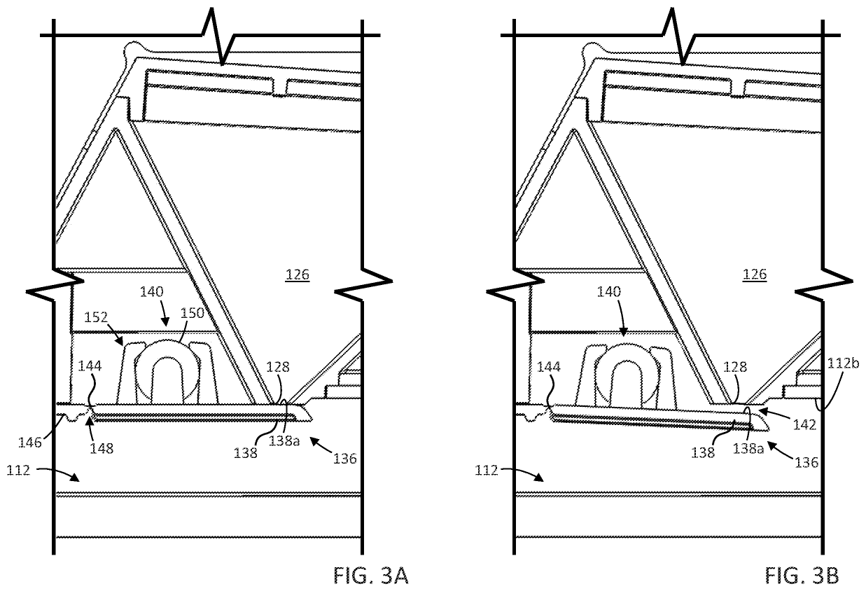

Referring to FIGS. 3A and 3B, in the example illustrated, the gate 138 vibrates away and towards the reservoir outlet 128 when the vibratory drive 140 is energized. In the example illustrated, the gate 138 vibrates between a closed position (shown in FIG. 3A, and also referred to as a first position) in which the gate 138 is against and blocks the reservoir outlet 128, and an open position (shown in FIG. 3B, and also referred to as a second position) spaced apart from the reservoir outlet 128 when the vibratory drive 140 is energized. In the example illustrated, the gate 138 is biased toward the closed position. In the example illustrated, the gate 138 is in the closed position when at rest, and the closed position corresponds to a resting position of the gate 138. In the example illustrated, the open position corresponds to a deflected position of the gate 138.

Referring to FIG. 3B, when the gate 138 is in the open position, a transfer channel 142 is provided between the reservoir outlet 128 and the first bee pathway 112 for transfer of the powdered inoculum from the reservoir outlet 128 to the first bee pathway 112. In the example illustrated, the transfer channel 142 is at least partially defined by an upper surface 138a of the gate 138 directed toward the reservoir outlet 128. In the example illustrated, when the gate 138 is in the open position, the upper surface 138a of the gate 138 is spaced apart from the reservoir outlet 128 by the transfer channel 142, and is oriented at a decline under the reservoir outlet 128 to facilitate conveyance of powdered inoculum received from the reservoir outlet 128 into the first bee pathway 112.

Referring to FIG. 3A, when the gate 138 is in the closed position, the transfer channel 142 is closed to inhibit transfer of the inoculum. In the example illustrated, when the gate 138 is in the closed position, the upper surface 138a of the gate 138 extends across and blocks a lower end of the reservoir outlet 128.

In the example illustrated, the gate 138 pivots about a horizontal pivot axis 144 when vibrating between the open and closed positions. In the example illustrated, the pivot axis 144 is generally parallel to the horizontal second axis 110 (FIG. 1), and generally perpendicular to the first pathway direction 116 (FIG. 2). In the example illustrated, the pivot axis 144 is spaced rearward of the reservoir outlet 128 toward the rear side 104a (FIG. 2) of the body 104.

Referring to FIG. 3A, in the example illustrated, the dispenser 136 includes a mount 146 fixed to the body 104, and the gate 138 is pivotably connected to the mount 146 at the pivot axis 144 via a living hinge 148. In the example illustrated, the living hinge 148 biases the gate 138 toward the closed position. The living hinge 148 accommodates movement of the gate 138 toward the open position, and when the gate 138 is in the open position, the living hinge 148 urges the gate 138 back toward the closed position. In the example illustrated, the gate 138, mount 146, and living hinge 148 are of integral, unitary, one-piece construction, and are formed of plastic in the example illustrated.

In the example illustrated, the vibratory drive 140 is supported by the gate 138. The vibratory drive 140 can include at least one vibrating disc motor. In the example illustrated, the vibratory drive 140 includes a disc motor 150 held by a motor coupling 152 mounted to an upper surface of the gate 138 rearward of the reservoir outlet 128. In some examples, the vibratory drive 140 can include a plurality of vibrating disc motors mounted to the gate 138. The disc motors can be spaced apart from one another along a length of the gate 138 extending parallel to the second axis 110. In the example illustrated, the disc motor 150 is oriented to impart vibrations in a vertical plane for vibrating the gate 138 away from and toward the reservoir outlet 128.

In other examples, the gate 138 can be generally fixed relative to the reservoir outlet 128 (e.g. not movable between open and closed positions), and the upper surface 138a of the gate 138 can be spaced apart (e.g. below) the reservoir outlet 128. Powder may flow through the reservoir outlet 128 and gather on the upper surface 138a of the gate 138, without being conveyed into the first bee pathway 112 when the gate 138 is at rest (i.e. to inhibit transfer of the powdered inoculum from the reservoir outlet 128 to the first bee pathway 112). Upon vibration of the gate 138, the powdered inoculum can migrate along the upper surface 138a and drop into the first bee pathway 112. In such examples, the upper surface 138a may be oriented at a decline under the reservoir outlet 128. The decline angle and spacing from the reservoir outlet 128 of the upper surface 138a can be selected such that the powdered inoculum accumulates and is retained on the upper surface 138a when the gate 138 is at rest, and flows toward and falls into the first bee pathway 112 when the gate 138 is vibrated. In such examples, the gate can vibrate in a plane generally parallel with the upper surface 138a when the vibratory drive is energized for inducing migration of the powdered inoculum along the upper surface 138a toward the first bee pathway 112. In such examples, the vibrating disc motor can be oriented to impart vibrations in the plane parallel to the upper surface 138a.

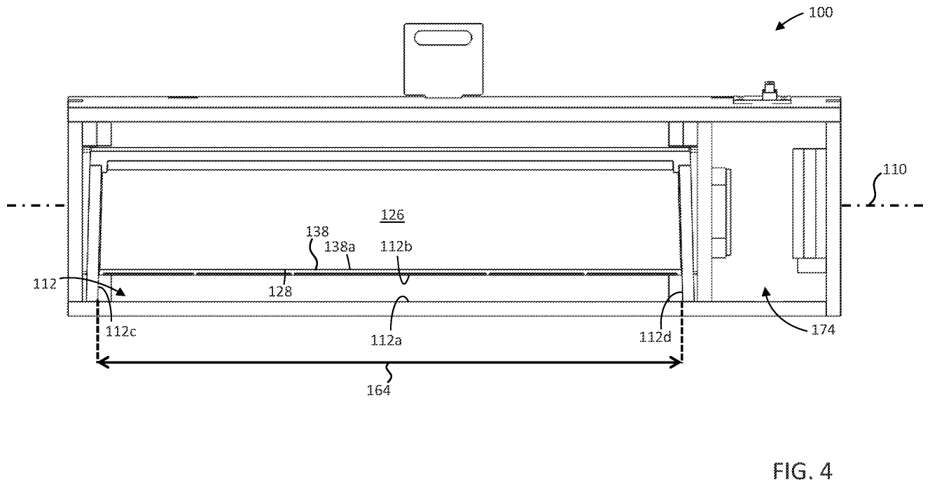

Referring to FIG. 4, in the example illustrated, the first bee pathway 112 is defined by a pathway floor 112a and a pair of spaced apart pathway sidewalls 112c, 112d extending between the pathway floor and a ceiling 112b above the pathway floor 112a. In the example illustrated, the gate 138 has an underside surface defining at least a portion of the ceiling 112b.

Referring to FIG. 2, in the example illustrated, the dispenser 136 is operable to drop the inoculum from the ceiling 112b and onto at least one target area 160 on the pathway floor 112a. Referring to FIG. 3B, when the gate is in the open position, the transfer channel 142 is open to the ceiling 112b for dropping the inoculum onto the target area 160 (FIG. 2). Referring back to FIG. 2, in the example illustrated, bees moving along the pathway floor 112a, for example, as the bees are exiting the hive to go foraging, walk through the target area 160, so that inoculum dispensed into the target area 160 may be picked up by and cling to the bees, for delivery to, for example, a target plant when the bees pollinate the target plant.

Referring still to FIG. 2, in the example illustrated, the ceiling 112b is spaced vertically apart (along the vertical axis 106, in the example illustrated) from the pathway floor 112a by a ceiling height. The ceiling height is selected to encourage bees to walk along the first bee pathway 112 through the target area 160 to facilitate dusting of the bees with the inoculum. For example, the ceiling height can be selected to discourage bees from flying through the first bee pathway 112.

Referring to FIG. 4, in the example illustrated, the pathway sidewalls 112c, 112d are spaced apart by a pathway width 164 near the target area 160 (FIG. 2). In the example illustrated, the pathway width 164 is generally parallel to the horizontal second axis 110, and generally perpendicular to the first pathway direction 116 (FIG. 2). In the example illustrated, the target area 160 (FIG. 2) extends over generally an entirety of the pathway width 164 to facilitate dusting of bees moving through the first bee pathway 112 with the inoculum. In the example illustrated, each of the reservoir 126, the reservoir outlet 128, the gate 138, and the transfer channel 142 (when the gate 138 is in the deflected position) extends over generally an entirety of the pathway width 164.

In some examples, all or portions of the pathway floor 112a of the first bee pathway 112 (e.g. at least over the target area 160) can be textured (e.g. with slight grooves and patterns) to help retain powdered inoculum on the pathway floor 112a and assist bees in walking along the pathway floor 112a. In some examples, some or all of the pathway floor of the second bee pathway 118 can be smooth and polished, to discourage bees from exiting the apparatus via the second bee pathway 118 (so that the bees are encouraged to exit the apparatus via the first bee pathway 112).

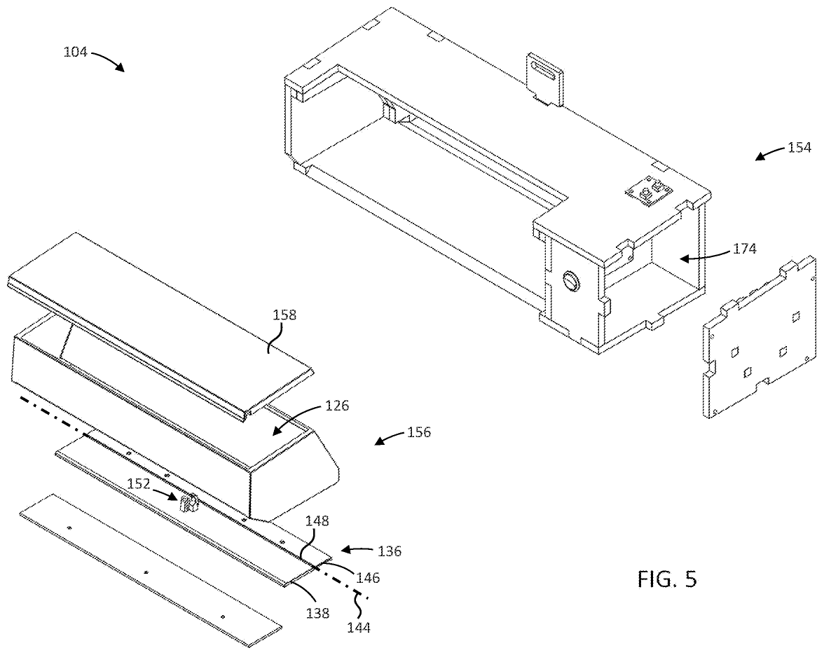

Referring to FIG. 5, in the example illustrated, the body 104 includes a frame 154 mountable to the hive 102 and a housing 156 removably mounted to the frame 154. The reservoir 126 is internal the housing 156, and the dispenser 136 is mounted to the housing 156. In the example illustrated, the housing 156 includes a lid 158 movable between an open position (FIG. 5) for providing access to the reservoir, and a closed position (FIG. 1) for covering the reservoir 126. In the example illustrated, the lid 158 is movable from the open position to the closed position when the housing 156 is removed from the frame 154. The lid 158 can be moved to the open position to supply inoculum by, for example, filling the reservoir 126 with inoculum or loading a cartridge 130. In the example illustrated, the lid 158 serves as the landing pad 122 (FIG. 2).

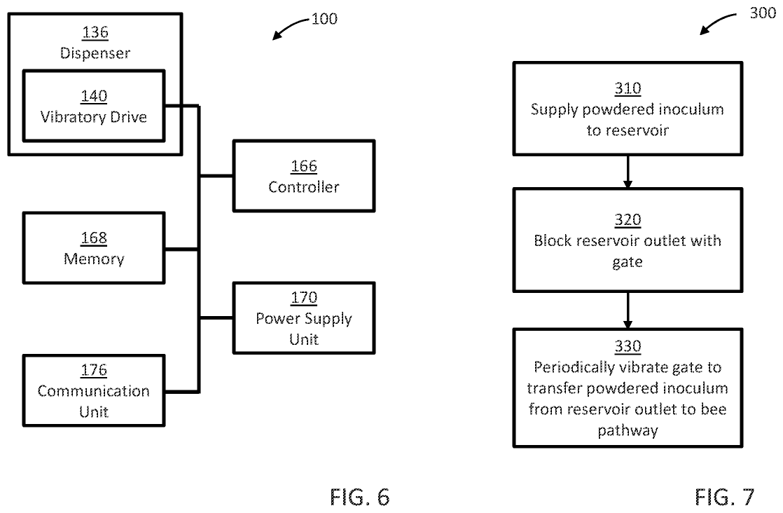

Referring to FIG. 6, the apparatus 100 further includes a controller 166 for controlling operation of the vibratory drive 140 according to one or more adjustable operating parameters. The controller 166 can include at least one computer processor, and one or more communication interfaces for providing communication between the processor and other system components. The operating parameters can be stored on, for example, computer-readable memory 168 in communication with the controller 166.

The operating parameters can correspond to, for example, one or more of a frequency of vibration, an amplitude of vibration, a dispensing time period during which to operate the vibratory drive to vibrate the gate, and/or an off time period during which to not operate the vibratory drive. The operating parameters can define a dispensing schedule according to which the vibratory drive is operated to dispense the powdered inoculum. The dispensing schedule can define, for example, time intervals at which to operate (e.g. energize) the vibratory drive, as well as the frequency and amplitude of vibration. This can provide for periodic dispensing of a predefined amount of the inoculum into the first bee pathway 112, and can facilitate more efficient use of inoculum and operation of the apparatus 100. The operating parameters can be adjusted to vary characteristics of the dispensing schedule, such as, for example, the rate at which inoculum is dispensed during vibration of the gate 138, and/or how often, for how long, and/or at what time the vibratory drive 140 is operated (e.g. energized).

In the example illustrated, the apparatus 100 further includes a power supply unit 170 for supplying power to components of the apparatus 100, such as, for example, the controller 166, memory 168, and/or dispenser 136. The power supply unit 170 can include a power storage unit, such as, for example, at least one battery. The power supply unit 170 can further include a solar power generator for charging the power storage unit. The solar power generator can include, for example, a plurality of solar cells. In the example illustrated, the controller 166, memory 168, and the power storage unit can be housed in a compartment 174 (FIG. 5) in the body 104.

In some examples, the apparatus 100 can further include a communication unit 176 operable to communicate with the controller 166. The communication unit can include a wireless communication unit and/or a local user interface mounted to the body 104. The communication unit 176 can operate to, for example, receive commands for modifying one or more of the operating parameters, and to transmit signals corresponding to the commands to the controller 166 to modify the one or more operating parameters. This can help allow for a user to, for example, control and/or adjust operation of the dispenser 136 by sending modification commands from a local user interface and/or a local or remote computer in communication with the communication unit 176.

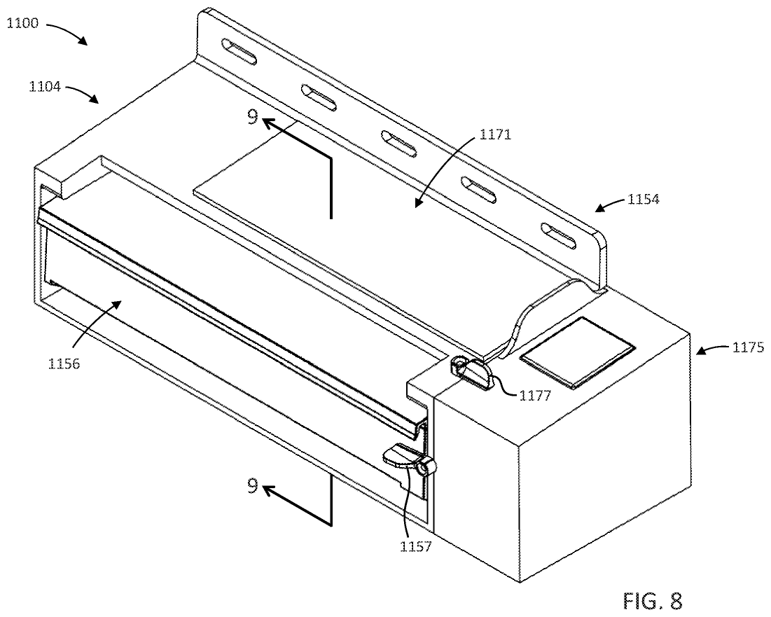

Referring to FIG. 7, a flow chart illustrating a method 300 of inoculating bees passing through the apparatus 100 is shown. At 310, powdered inoculum is supplied to the reservoir 126. At 320, the reservoir outlet 128 is blocked with the gate 138 to inhibit flow of the powdered inoculum from the reservoir outlet 128 and into the first bee pathway 112. At 330, the gate 138 is periodically vibrated (e.g. by energizing the vibratory drive 140) to transfer the powdered inoculum from the reservoir outlet 128 and into the first bee pathway 112 to dust bees exiting the hive 102 via the first bee pathway 112 with the powdered inoculum. In the example illustrated, step 330 includes oscillating the gate 138 toward and away from the closed (resting) position.

The reservoir 126 can be sized to store an amount of powdered inoculum for approximately, for example, two weeks of dispensing according to the dispensing schedule. After the inoculum is depleted from the reservoir 126, inoculum can be resupplied by, for example, refilling the reservoir with inoculum, or removing a depleted cartridge from the housing 156 and installing a fresh cartridge for further dispensing of inoculum. The depleted cartridge can be discarded, or returned to a suitable facility for recycling and/or refilling and resealing for subsequent use.

Referring to FIG. 8, another example inoculum transfer apparatus 1100 is illustrated. The inoculum transfer apparatus 1100 has similarities to the apparatus 100, and like features are identified with like reference characters, incremented by 1000.

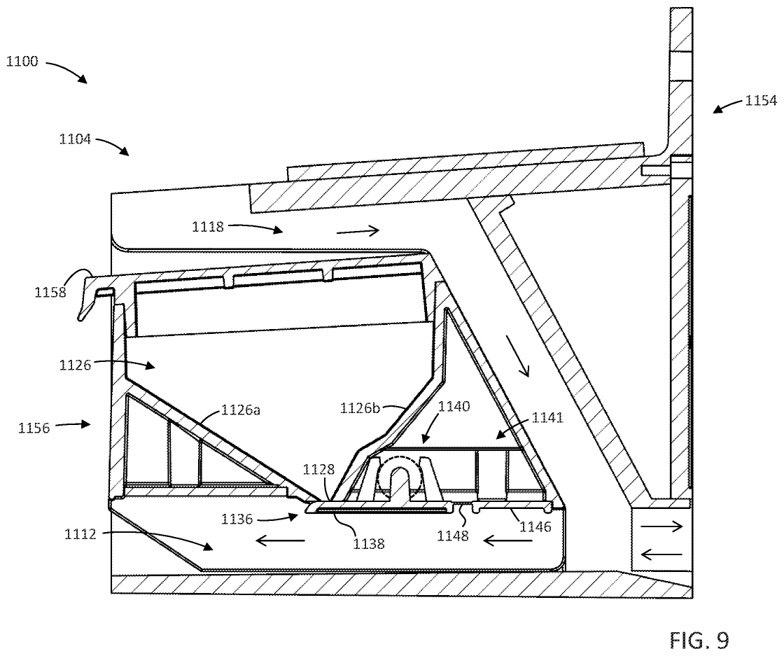

Referring to FIG. 9, the inoculum transfer apparatus 1100 includes a body 1104 mountable to a hive, a first bee pathway 1112 in the body 1104, a second bee pathway 1118 in the body, and a reservoir 1126 in the body 1104 at an elevation above the first bee pathway 1112 for storing a powdered inoculum.

In the example illustrated, the reservoir 1126 has a reservoir outlet 1128 at a lower end thereof. The powdered inoculum can be loaded into the reservoir 1126 directly (e.g. without using a cartridge), and is in communication with the reservoir outlet 1128 when loaded in the reservoir 1126. In the example illustrated, the reservoir 1126 has a front wall 1126a and a rear wall 1126b spaced apart from and directed toward the front wall 1126a. Each of the front wall 1126a and the rear wall 1126b extends from an upper end to the reservoir outlet 1128, and is shaped for directing powdered inoculum loaded in the reservoir 1126 toward the reservoir outlet 1128.

In the example illustrated, the apparatus 1100 further includes a vibratory dispenser 1136 in the body 1104 for controlling dispensing of the powdered inoculum from the reservoir outlet 1128 into the first bee pathway 1112. The dispenser 1136 includes a gate 1138 beneath the reservoir outlet 1128. In the example illustrated, the gate 1138 is biased toward a closed position (shown in FIG. 9, and also referred to as a first or resting position) in which the gate 1138 inhibits transfer of the powdered inoculum from the reservoir outlet 1128 into the first bee pathway 1112. The dispenser 1136 includes a vibratory drive 1140 coupled to the gate 1138 for vibrating the gate 1138 to induce transfer of the powdered inoculum from the reservoir outlet 1128 into the first bee pathway 1112. In the example illustrated, when the gate 1138 is vibrated via the vibratory drive 1140, the gate 1138 oscillates between the closed position and an open position (also referred to as a second or deflected position) spaced apart from the closed position (spaced below the closed position, in the example illustrated). When the gate 1138 is in the open position, a transfer channel is provided between the reservoir outlet 1128 and the first bee pathway 1112 for transfer of the powdered inoculum from the reservoir outlet 1128 to the first bee pathway 1112. The transfer channel is closed when the gate 1138 is in the closed position.

In the example illustrated, the vibratory dispenser 1136 includes a mount 1146 fixed to the body 1104, and the gate 1138 is pivotably connected to the mount 1146 via a living hinge 1148 biasing the gate 1138 toward the closed position. In the example illustrated, the gate 1138, mount 1146, and living hinge 1148 are of integral, unitary, one-piece construction.

In the example illustrated, each of the gate 1138, the mount 1146, and the living hinge 1148 has an underside surface defining at least a portion of a ceiling of the first bee pathway 1112. In the example illustrated, the vibratory drive 1140 is supported atop an upper surface of the gate 1138 opposite the underside surface. In the example illustrated, when the gate 1138 is in the resting position, the vibratory drive 1140 is contained in a generally enclosed drive compartment 1141 between the first bee pathway 1112 and the second bee pathway 1118. In the example illustrated, the drive compartment 1141 is rearward of the reservoir 1126.

In the example illustrated, the body 1104 includes a frame 1154 mountable to the hive and a housing 1156 removably mounted to the frame 1154. In the example illustrated, the housing 1156 is securable to the frame by a housing latch 1157 (FIG. 8). The reservoir 1126 and the drive compartment 1141 are internal the housing 1156, and the dispenser 1136 is mounted to the housing 1156. In the example illustrated, the body 1104 includes a mounting bracket 1127 for mounting the body 1104 to the hive. In the example illustrated, the mounting bracket 1127 is formed integrally with portions of the frame 1154.

In the example illustrated, the housing 1156 includes a lid 1158 movable between an open position for providing access to the reservoir 1126 (e.g. for loading powdered inoculum), and a closed position for covering the reservoir 1126. One or more seals can be provided about a lower periphery of the lid 1158 or an upper periphery of the reservoir 1126 for generally sealing the reservoir 1126 when the lid 1158 is in the closed position.

Referring to FIG. 8, in the example illustrated, the apparatus 1100 further includes a power supply unit for supplying power to components of the apparatus 1100, such as, for example, a controller, memory, communication unit, and/or the dispenser 1136. The power supply unit can include a power storage unit, such as, for example, at least one battery, and in the example illustrated, the power supply unit further includes one or more solar cells 1171 mounted atop the apparatus 1110. In the example illustrated, the body 1104 includes a case 1175 detachably mounted to the frame 1154 and having one or more internal compartments for housing at least some of the control and/or power components of the apparatus 1100 (e.g. a controller, memory, power storage unit, communication unit, etc.). In the example illustrated, the case 1175 can be secured to the frame 1154 by a case latch 1177.

1. An inoculum transfer apparatus for a bee hive having a hive opening, comprising:
a) a body mountable to the hive intermediate the hive opening and an outside environment;
b) a bee pathway in the body for providing passage for bees between the hive opening and the outside environment;
c) a reservoir in the body at an elevation above the bee pathway for storing powdered inoculum, the reservoir having a reservoir outlet at a lower end thereof; and
d) a vibratory dispenser in the body adjacent the reservoir outlet for controlling dispensing of the powdered inoculum from the reservoir outlet to the bee pathway via a vibratory drive.

2. The apparatus of claim 1, wherein the vibratory dispenser includes a gate below the reservoir outlet and coupled to the vibratory drive, the gate inhibiting transfer of powdered inoculum from the reservoir outlet to the bee pathway when at rest, and the vibratory drive energizable to vibrate the gate for inducing transfer of powdered inoculum from the reservoir outlet to the bee pathway.

3. The apparatus of claim 2, wherein the gate has an upper surface facing the reservoir outlet for receiving the powdered inoculum.

4. The apparatus of claim 3, wherein the gate vibrates in a plane generally parallel with the upper surface when the vibratory drive is energized.

5. The apparatus of claim 2, wherein the gate vibrates away from and toward the reservoir outlet when the vibratory drive is energized.

6. The apparatus of claim 5, wherein the gate vibrates between a closed position against the reservoir outlet and an open position spaced apart from the reservoir outlet when the vibratory drive is energized.

7. The apparatus of claim 6, wherein the gate is biased toward the closed position.

8. The apparatus of claim 6, wherein when the gate is in the open position, a transfer channel is provided between the reservoir outlet and the bee pathway for transfer of the powdered inoculum from the reservoir to the bee pathway, and when the gate is in the closed position the transfer channel is closed.

9. The apparatus of claim 6, wherein the gate pivots about a horizontal pivot axis when vibrating between the open and closed positions.

10. The apparatus of claim 9, wherein the vibratory dispenser includes a mount fixed to the body, and wherein the gate is pivotably connected to the mount at the pivot axis via a living hinge.

11. The apparatus of claim 10, wherein the living hinge biases the gate toward the closed position.

12. The apparatus of claim 1, wherein the vibratory drive comprises a vibratory disc motor.

13. The apparatus of claim 1, wherein the body includes a frame mountable to the hive and a housing removably mountable to the frame, the reservoir internal the housing and the dispenser mounted to the housing.

14. The apparatus of claim 13, wherein the housing includes a lid movable between an open position for providing access to the reservoir, and a closed position for covering the reservoir.

15. The apparatus of claim 1, further comprising a controller for controlling operation of the vibratory drive according to one or more adjustable operating parameters.

16. The apparatus of claim 15, wherein the operating parameters correspond to at least one of a frequency of vibration and an amplitude of vibration.

17. The apparatus of claim 15, wherein the operating parameters correspond to at least one of a dispensing time period during which to energize the vibratory drive, and an off time period during which to not energize the vibratory drive.

18. An inoculum transfer apparatus for a bee hive having a hive opening, comprising:
a) a body mountable to the hive;
b) a bee pathway in the body for providing passage for bees between the hive opening and an outside environment external the hive;
c) a reservoir in the body above the bee pathway for storing a powdered inoculum, the reservoir having a reservoir outlet at a lower end thereof; and
d) a dispenser in the body for controlling dispensing of the powdered inoculum from the reservoir to the bee pathway, the dispenser including a gate adjacent the reservoir outlet, the gate movable between a first position in which the reservoir outlet is closed by the gate to inhibit transfer of the powdered through the reservoir outlet and a second position spaced apart from the first position and in which the reservoir outlet is open for dispensing the powdered inoculum from the reservoir toward the bee pathway, and the dispenser further including a drive coupled to the gate for moving the gate at least from the first position to the second position.

19. The apparatus of claim 18, wherein the gate is biased toward the first position.

20. A method of inoculating bees passing through an inoculum transfer apparatus mounted to a bee hive, comprising:
a) supplying a reservoir of the apparatus with powdered inoculum, the reservoir including a reservoir outlet at a lower end thereof; and
b) periodically energizing a vibratory drive to vibrate a gate positioned below the reservoir outlet to induce transfer of the powdered inoculum from the reservoir to the bee pathway to dust bees exiting the hive via the bee pathway with the powdered inoculum.
